(19) United States
(12) Patent Application Publication
(10) Pub. No.: US 2005/0044679 A1
(43) Pub. Date: Mar. 3, 2005

(54) Apparatus and method for forming duct members

(75) Inventor: Victor Bota, Brooklyn, OH (US)

Correspondence Address: HAHN LOESER & PARKS, LLP, One GOJO Plaza, Suite 300, AKRON, OH, 44311-1076, US

(73) Assignee: Cleveland Tool & Machine, Inc.

(21) Appl. No.: 10/659,532

(22) Filed: Sep. 10, 2003

Related U.S. Application Data
(60) Provisional application No. 60/492,510, filed on Aug. 5, 2003.

(51) Int. Cl. B23P 19/04

(52) U.S. Cl. 29/237

(57) ABSTRACT

An apparatus and method for forming a duct member, wherein the duct member is a reducer/expander having a first cylindrical portion of a first diameter, a second cylindrical portion of a second diameter, and a frustoconical portion therebetween and coupled to each cylindrical portion in a manner requiring minimized operator handling of the blanks. The apparatus comprises a first work station and a second work station. The first work station comprising a channel for accommodating a first cylindrical work piece of a first diameter and a first positioning member for aligning a frustoconical work piece for coupling to the first cylindrical work piece. The second work station comprising a channel for accommodating a second cylindrical work piece of a second diameter and a second positioning member for aligning a frustoconical work piece for coupling to the second cylindrical work piece. The first and second work stations each have a coupling assembly which cooperates with a respective die to selectively couple the frustoconical work piece and the respective cylindrical work pieces to form an expander/reducer with minimum operator handling.

This application claims the benefit of U.S. Provisional Patent Ser. No. 60/492,510, filed Aug. 5, 2003, hereby incorporated by reference. The invention is generally directed to an apparatus and method for forming a duct member, and more particularly to the automated manufacture of the annular seams of a reducer/expander for an HVAC duct system, which requires minimized operator interaction.

### TECHNICAL FIELD

### BACKGROUND OF THE INVENTION

In general, ductwork is commonly used in forced air heating and air conditioning systems for buildings and the like. To facilitate installation of a ductwork system and to properly regulate the airflow, various types of duct members have been developed, including reducer/expansion duct members. Depending on the direction of the airflow through the duct member, the reducer can increase airflow velocity while the expander reduces airflow velocity. Reducer/expander ducts typically have a plurality of sections, which are fixably attached to one another to form the duct member. The reducer/expander duct members typically have two cylindrical portions having different diameters and a frustoconical portion in between which has one end mating with the larger of the cylindrical portions and a second end mating with the smaller of the cylindrical portions.

Reducer/expanders are currently manufactured in a fairly manual process which typically takes about five minutes to produce a single part. The operator aligns the conical and cylindrical ends of two blanks and then activates a machine or hand tools to couple the parts and then repeats the cycle with the other end of the conical section. The operator is typically supporting or holding the conical section during the joining processes which puts them at risk for injury. The operator must be a skilled laborer to properly form the reducer/expander and the manual operation requires a high level of concentration. Improper alignment can result in too much overlap which wastes material and make the overall length of the member too short; or too little overlap allowing the two portions to become uncoupled. The constant manipulation of the parts by the operator can also result in carpal tunnel syndrome.

It would therefore be desirable to provide a more automated manufacture of a reducer/expander duct member, without requiring the extensive foregoing manual operation.

### SUMMARY OF THE INVENTION

Based upon the foregoing, the present invention is directed at an apparatus and method for forming a duct member, wherein the duct member is a reducer/expander having a first cylindrical portion of a first diameter, a second cylindrical portion of a second diameter, and a frustoconical portion therebetween and coupled to each cylindrical portion in a manner requiring minimized operator handling of the blanks. These and other advantages are provided by an apparatus for forming a reducer/expander duct member for use in an air handling system comprises a housing comprising a first work station and a second work station; the first work station comprising a channel for accommodating a first cylindrical work piece of a first diameter and a first positioning member for aligning a frustoconical work piece for coupling to the first cylindrical work piece; the second work station comprising a channel for accommodating a second cylindrical work piece of a second diameter and a second positioning member for aligning a frustoconical work piece for coupling to the second cylindrical work piece, a first die associated with said first work station which is selectively positioned at a predetermined location relative the frustoconical work piece and the first cylindrical work piece positioned in said first work station, a second die associated with said second work station which is selectively positioned at a predetermined location relative to said frustoconical work piece and the second cylindrical work piece positioned in said second work station, wherein said first and second dies are different sizes adapted to accommodate different diameters of the first and second cylindrical work piece, a first coupling assembly associated with said first work station which cooperates with said first die to selectively couple the frustoconical work piece and the first cylindrical work piece, a second coupling assembly associated with said second work station which cooperates with said second die to selectively couple the frustoconical work piece and the second cylindrical work piece.

Other objectives and advantages of the invention will become apparent from the following description, taken in conjunction with the drawings.

### BRIEF DESCRIPTION OF THE DRAWINGS

FIG. 1 is a side elevational view of the two cylindrical and one frustoconical member used in the apparatus of the present invention in making a reducer/expander duct member accordance with the method of the present invention;

FIG. 2 is a side elevational view of the two cylindrical and one frustoconical member of FIG. 1 as they are positioned prior to coupling in different stages in accordance with the present invention;

FIG. 3 is a side elevational view of a finished a reducer/expander duct member as removed from the apparatus of the present invention;

FIG. 4 is a plan view of an apparatus for forming an adjustable duct member in accordance with the present invention;

FIG. 5A is a plan view of a first positioning member used with the apparatus as shown in FIG. 4, and FIG. 5B is a cross-sectional view of the first positioning member of FIG. 5A;

FIG. 6 is a partial sectional view of the first work position of the apparatus as shown in FIG. 4; and

FIG. 7 is a partial sectional view of the second work position of the apparatus as shown in FIG. 4.

### DETAILED DESCRIPTION OF THE INVENTION

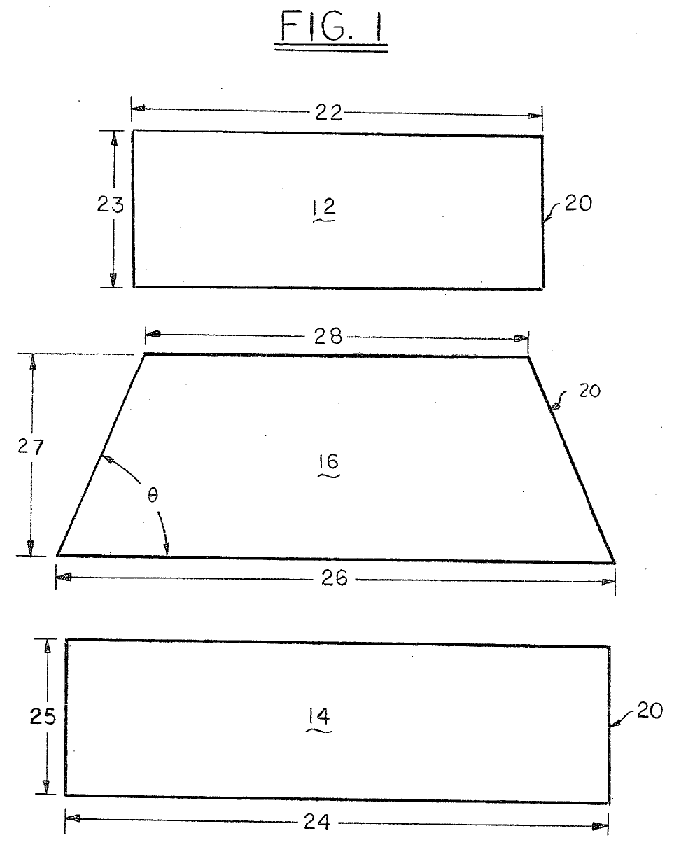

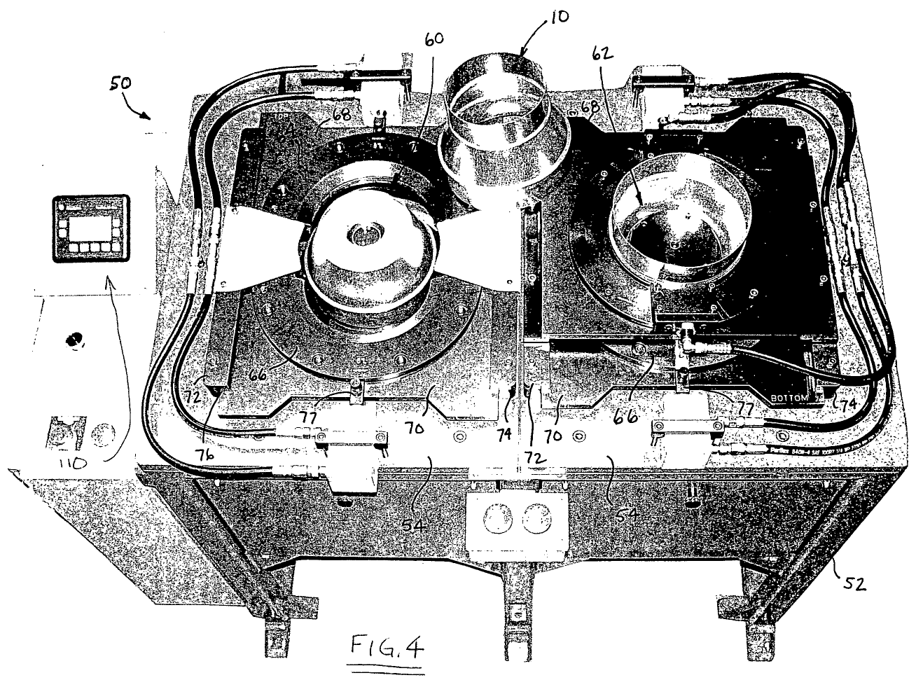

Turning now to FIGS. 1-3, the invention is directed at producing a reducer/expander duct member 10 such as shown in FIG. 3, wherein the reducer/expander 10 is produced from work pieces 20 as shown in FIG. 1, comprising a first cylindrical portion 12 of a first diameter 22 and a first length 23, a second cylindrical portion 14 of a second diameter 24 and a second length 25, and a frustoconical portion 16 formed at a conical angle Θ having a first end diameter 26, a second end diameter 28, and an axial length 27. Work pieces 20 may be produced from a flat blank of material which is rolled such that opposed seams of the blank slightly overlap and are coupled to one another to form the tubular work piece configuration 12, 14, or the frustoconical work piece configuration 16. Coupling at the overlapping seams may be provided in any suitable manner, such as by riveting or the like. The work pieces 20 provide starting material which may then be operated on by the apparatus and methods of the invention.

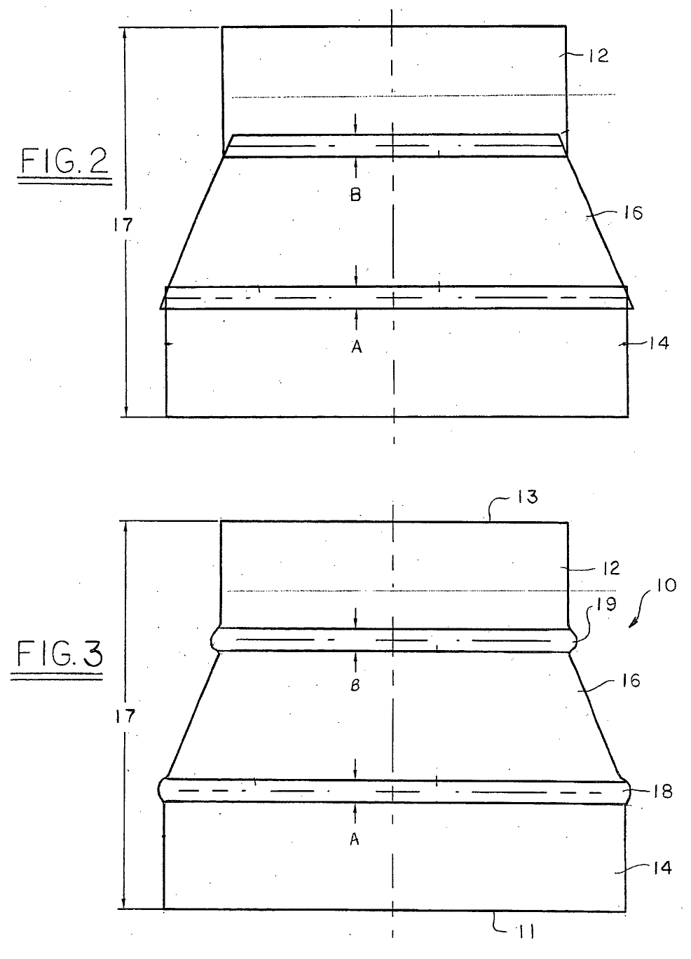

As will be discussed in greater detail below, the work piece portions 12, 14, and 16 are positioned as shown in FIG. 2 having overlapping ends as depicted at A and B prior to coupling in the apparatus 50 of the present invention to form the coupling seams 18, 19 of the finished article 10 of FIG. 3, comprising an inlet opening 11 (when used as a reducer), an outlet opening 13, and an axial length 17 being adapted to be coupled between other members in a duct system having respective diameters and associated with an air handling system.

Turning now to FIGS. 4-7, an embodiment of the apparatus according to the invention is shown in more detail. The apparatus generally designated 50 includes a housing or frame construction 52 which supports various components of the apparatus. Housing or frame 52 includes an upper surface 54 which is mounted to the frame 52. The upper surface 54 of the apparatus 50 may include two work stations or nests generally designated 60 and 62, each of which is formed as a recess adapted to accept the work pieces 20 discussed in previous figures to perform the operations to couple the work pieces 20 as described below. Alternatively, the apparatus of the invention could utilize only one workstation in which multiple coupling steps could be performed to fabricate the desired reducer/expander duct member. The workstation would provide the coupling bead forming steps in at least two predetermined locations, and with the tapered tube, would accommodate different diameters of the tube to perform these steps.

In the particular embodiment shown, each of the nests 60, 62 and associated components to perform those operations are substantially identical in many respects, except that the work pieces 20 are positioned differently in each nest 60 or 62 to form the coupling operations to produce the reducer/expander duct member 10 of the invention. As shown in the figures, each nest 60 or 62 can include a die supported on the upper surface, which in the preferred embodiment may be comprised of first and second semicircular members 64 and 66 which are positioned on opposed sides of the nests 60 or 62. The die members 64 and 66 are positioned immediately adjacent the nest 60 or 62 in operation, but preferably may be moved into a nonoperational position away from the nest 60 or 62 when desired in a manufacturing cycle. Therefore, each of the die members 64 and 66 may be supported in association with a slidable plate 68 and 70 which is supported in sliding engagement with support blocks 72 and 74 in a channel or slot 76. The support block 74 may be adjusted relative to the plates 68 and 70 for smooth slidable operation of the plates within slot 76. Each of the plates 68 and 70 may be moveable toward and away from the nest 60 or 62 by means of a hydraulic ram 77 or other suitable mechanism. Within the nest 60 or 62, a coupling system 80 is provided in the recessed portion of the nest 60 or 62. Between the die members 64 and 66 and the coupling system 80, a circular channel 82 is formed by the recess of the nest 60 or 62, the channel 82 being dimensioned to accept one of the cylindrical members 12, 14 and the frustoconical member 16. In FIG. 4, a cylindrical member 14 is shown coupled to frustoconical member 16 within nest 60 and cylindrical member 12 is shown coupled to frustoconical member 16 within nest 62 to form a finished reducer/expander 10 as also shown positioned on the apparatus 50. Die members 64 and 66 are designed to cooperate with one another to form, when positioned adjacent the work piece, a stationary form into which material of the work piece 20 is pushed by the coupling system 80. Preferably the die members 64 and 66 are formed to include a recess, which will cooperate with a portion of the coupling system 80 to generate an outwardly directed bead in the work piece 20 of substantial depth. It is pointed out that, die members 64 and 66 also perform a clamping function in addition to the forming function of the die. This enables both sections to be properly secured during and after the coupling operation.

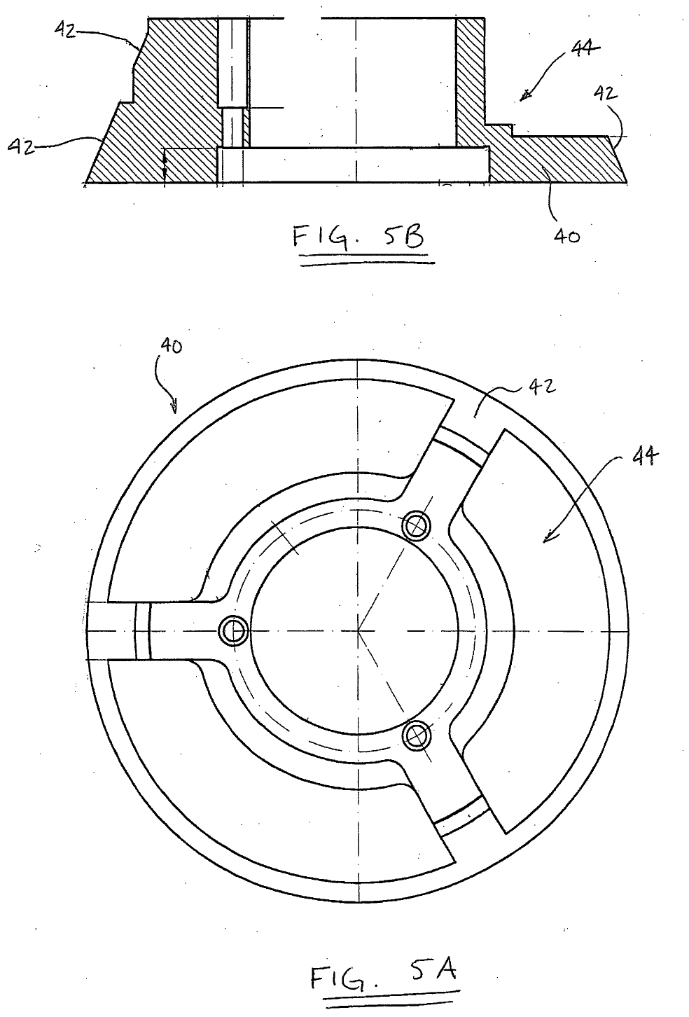

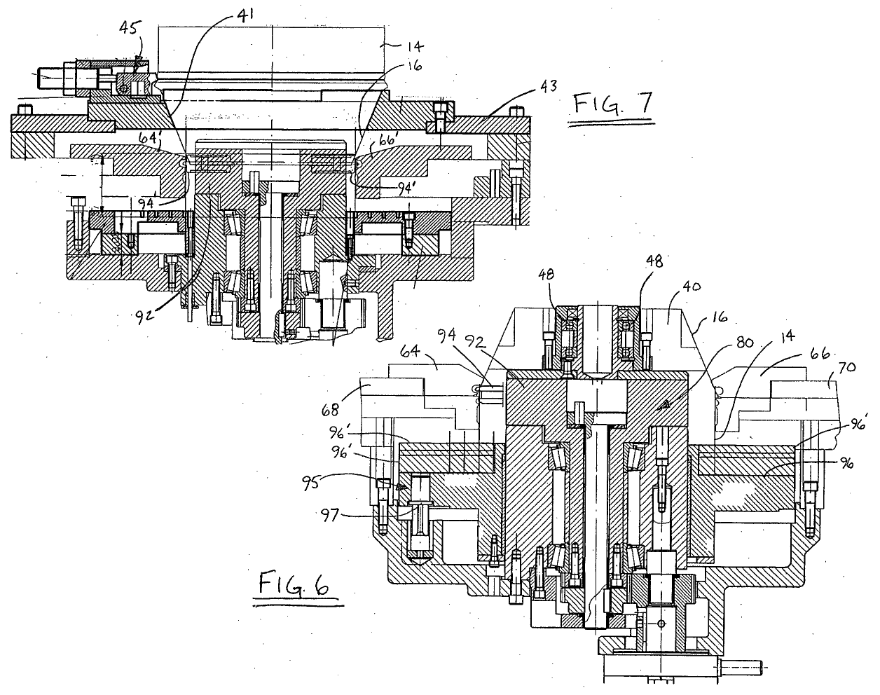

The nests 60, 62 are best shown in FIGS. 6 and 7, respectively. Nest 60 includes a positioning member 40 (shown in detail in FIGS. 5A-5B) which aligns the frustoconical work piece 16 for coupling to the cylindrical work piece 16. As shown in FIGS. 5A-5B, positioning member 40 may include conically angled surfaces 42 corresponding to frustoconical blank 16 such that the operator merely places the frustoconical work piece 16 onto the positioning member 40 and the frustoconical blank 16 slides downward into the proper position. In addition to conically to angled surfaces 42, positioning member 40 may comprise cut out or clearance portions 44 which enable the operator to put their fingers underneath the frustoconical work piece 16 mounted on the positioning member 40 to facilitate the removal thereof after the work pieces 14, 16 are connected to each other. Referring again to FIG. 6, nest 60 further comprises a coupling assembly 80 comprising a rotating head 92 having at least one coupling bead wheel 94 extendable therefrom on a sliding block (not shown) similar to known duct forming machines disclosed in U.S. Pat. Nos. 6,105,227; 6,363,764; and 6,378,184; all herein incorporated by reference. The coupling bead wheel 94 cooperates with the dies 64, 66 to couple the frustoconical work piece 16 and the first cylindrical work piece 14.

In operation, the operator inserts the cylindrical member 14 into channel 82 where it registers against a base plate 96. The base plate 96 is positioned in a predetermined location and ensures that the end of the cylindrical member 14 to be coupled is in a proper height in apparatus 50. Annular base plate inserts 96′ may also be used to adjust the effective position of the base plate 96 and the corresponding position of the cylindrical member 14. The operator then places frustoconical work piece 16 on positioning member 40. The diameter 26 of the end of the frustoconical work piece 16 is larger than the diameter of the cylindrical member 14 such that the frustoconical work piece 16 overlaps the end of the cylindrical member 14. The dies 64, 66 are then extended inward. The dies 64, 66 may have angled leading surfaces 65, 67, respectively, which correspond to the conical angle of the frustoconical work piece 16. The leading surfaces 65, 67 of dies 64, 66 and engage the frustoconical work piece 16 forcing the frustoconical work piece 16 downward and into an interference overlap (in FIG. 4 the end of the cylindrical member 14 is shown in their initial position) such that the end of the cylindrical member 14 will bow slightly inward (not shown). Once clamped into position by the dies 64, 66, the head 92 rotates and the coupling bead wheel 94 is engaged to couple the cylindrical member 14 and the frustoconical work piece 16. It is noted that the positioning member 40 may be mounted to the rotating head 92 through bearings 48 which allow the positioning member 40 and the frustoconical work piece 16 to be held in a stationary position by the dies 64, 66 while the rotating head 92 is engaged to couple the work pieces 14, 16. The apparatus 50 may also comprise and ejection system 95 comprising at least one piston 97 which is hydraulically actuated to elevate the base plate 96. Such that the work pieces 14, 16 are elevated above the apparatus 50 where the operator can more easily removed the work pieces 14, 16 from the nest 60 of the apparatus 50. The removal of the work pieces 14, 16 is also enhanced by the clearance sections 44 of the positioning member 40 which allow access to the frustoconical work piece 16.

The nest 60 may be used with a variety of different sizes and is only limited by the range of motion of the slide block and attached coupling bead wheel 94. The dies 64, 66 are easily removed and replaced with dies of a size corresponding to the new diameter of the cylindrical work piece. Different lengths 25 of work piece 14 can be accommodated by using the annular inserts 96′ on top of base plate 96. the positioning number 40 can also be easily removed and replaced on the rotating head 92 with a positioning member corresponding to the size of the new frustoconical work piece.

Referring now to FIG. 6, the second work station or nest 62 is shown in greater detail. Nest 60 includes a positioning member 41 which aligns the frustoconical work piece 16 for coupling to the cylindrical work piece 12. The positioning member 41 is shown suspended over the dies 64′, 66′ by positioning member plate 43. The positioning member 41 is configured as an annular ring with the central aperture having an inverted conical form such that the positioning member 41 guides the exterior surface of the frustoconical work piece 16 into a proper position within the nest 62. The positioning member 41 may also include one or more clamp assemblies 45 which engage the attached work pieces 14, 16 to hold the attached work pieces 14, 16 in position during attachment of the second cylindrical work piece 12. Nest 62 further comprises a coupling assembly 80 comprising a rotating head 92′ having at least one coupling bead wheel 94′ extendable therefrom on a sliding block similar to the first work station or nest 60. The coupling bead wheel 94′ cooperates with the dies 64′, 66′ to couple the frustoconical work piece 16 and the second cylindrical work piece 12.

In operation, the operator inserts the cylindrical member 12 into channel 82 where it registers against a base plate 196. The base plate 196 is positioned in a predetermined location and ensures that the end of the cylindrical member 12 to be coupled is in a proper height in apparatus 50. The base plate 196 may also be configured with annular slots 197 positioned for various diameters of cylindrical members. The operator then places frustoconical work piece side of the combined frustoconical work piece 16 and attached cylindrical work piece 14 into positioning member 41. The clamp assemblies 45 are extended radially inward in a manner helping to force the frustoconical work piece 16 into a proper position for attachment with cylindrical work piece 12. The diameter 28 of the end of the frustoconical work piece 16 is smaller than the diameter 22 of the cylindrical member 12 such that the frustoconical work piece 16 overlaps the interior of the end of the cylindrical member 12. The dies 64′, 66′ are then extended inward. Once the work pieces 12, 16 and 14 are clamped into position by the dies 64, 66, and clamp assemblies 45, the head 92′ rotates and the coupling bead wheel 94′ is engaged to couple the cylindrical member 12 and the frustoconical work piece 16. It is noted that the cylindrical work piece 12 is held in a stationary position by the dies 64, 66 and frustoconical work piece 16 is held in a stationary position by clamp assemblies 45 while the rotating head 92 is engaged to couple the work pieces 12, 16. The resultant product is a finished reducer/expander duct member 10. The dies 64′, 66′ and clamp assemblies 45 are then disengaged from the finished reducer/expander duct member 10. The operator can then easily remove the finished reducer/expander duct member 10 from the apparatus 50 by grasping the large cylindrical portion 14 which extends upward above the nest 62.

The nest 62 may be also be used with a variety of different sizes and is only limited by the range of motion of the slide block and attached coupling bead wheel 94′. The dies 64′, 66′ are easily removed and replaced with dies of a size corresponding to the new diameter of the cylindrical work piece. Different lengths 25 of work piece 14 can be accommodated by adjustably moving the base plate 96 upwards or downward. The positioning member 41 can also be easily removed and replaced on the rotating head 92 with a positioning member corresponding to the size of the new frustoconical work piece.

The apparatus 50 also preferably includes a control system generally designated 110, which may be any suitable system such as a microprocessor or PLC based system, to selectively perform the various operations and steps to produce the reducer/expander duct member 10 according to the methods of the invention. Preferably, control system 110 can be designed to automatically perform various operations in a manufacturing sequence to produce a particular size of reducer/expander duct member 10. Each different size of reducer/expander duct member will effectively have a process sequence recipe that can be simply recalled using the control system 110, with subsequent automated performance of each step in the manufacture of the reducer/expander duct member 10. In this way, an unskilled operator can simply recall a particular recipe for the size of the reducer/expander duct member to be produced, alleviating the necessity for a skilled operator and simplifying the manufacturing process.

Therefore as discussed above, the operator has minimal contact with the work pieces during construction of the reducer/expander duct member. The operator places the first and second cylindrical work pieces in their respective nests, places the frustoconical work piece in the first nest on the first positioning member, removes that connected frustoconical work piece and first cylindrical work piece from the first nest and places it in an inverted configuration into the second nest, then removes the finished article from the apparatus. The cycle time to produce the reducer/expander duct member is reduced from over five minutes to less than 15 seconds.

Although the present invention has been shown to produce a particular reducer/expander duct member in the form of a standard, four-gore, ninety degree elbow, any duct member having adjustable gores formed at any angle is contemplated. While the above description has been presented with specific relation to a particular embodiment of the invention and methods of producing a specific reducer/expander duct member, it is to be understood that the claimed invention is not to be limited as such and that certain changes may be made without departing from the scope of the invention with the above description intended to be interpreted as illustrative and not limiting.

1. An apparatus for forming a reducer/expander duct member for use in an air handling system comprising,
a housing comprising a first workstation and a second workstation;
the first work station comprising a channel for accommodating a first cylindrical work piece of a first diameter and a first positioning member for aligning a frustoconical work piece for coupling to the first cylindrical work piece;
the second work station comprising a channel for accommodating a second cylindrical work piece of a second diameter and a second positioning member for aligning a frustoconical work piece for coupling to the second cylindrical work piece,
a first die associated with said first work station which is selectively positioned at a predetermined location relative the frustoconical work piece and the first cylindrical work piece positioned in said first work station,
a second die associated with said second work station which is selectively positioned at a predetermined location relative to said frustoconical work piece and the second cylindrical work piece positioned in said second work station,
wherein said first and second dies are different sizes adapted to accommodate different diameters of the first and second cylindrical work piece,
a first coupling assembly associated with said first work station which cooperates with said first die to selectively couple the frustoconical work piece and the first cylindrical work piece, and
a second coupling assembly associated with said second work station which cooperates with said second die to selectively couple the frustoconical work piece and the second cylindrical work piece.

2. The apparatus of claim 1, wherein the first positioning member is at least partially formed as a conical section.

3. The apparatus of claim 1, wherein the second positioning member is at least partially formed having a conical aperture.

4. The apparatus of claim 1 further comprising a part ejection system associated with the first workstation.

5. The apparatus of claim 1, wherein the first positioning member comprises a clearance portion allowing an operator to access and remove the frustoconical work piece and the attached first cylindrical work piece.

6. The apparatus of claim 1, wherein the first and second coupling assemblies each comprise at least one coupling bead wheel.

7. The apparatus of claim 1, wherein the second work station further comprises a clamping system to properly position and secure the frustoconical work piece and the attached first cylindrical work piece in a predetermined position for attachment of the second cylindrical work piece to the frustoconical work piece.

8. The apparatus of claim 1 further comprising a base plate at the bottom of each insertion channel of the first and second workstation.

9. The apparatus of claim 4, wherein the part ejection system comprises at least one hydraulically actuated piston positioned to raise a base plate at the bottom of the insertion channel of the first workstation.

10. The apparatus of claim 1, wherein the coupled portions of the reducer/expander duct member are formed perpendicular to a longitudinal axis of the reducer/expander duct.

11. The apparatus of claim 1, wherein the first die of the first workstation is adapted to exert a force against the frustoconical work piece and toward the first cylindrical work piece positioned within the insertion channel of the first workstation.

12. The apparatus of claim 1, wherein the first coupling assembly further comprises a rotating head.

13. The apparatus of claim 12, wherein the first positioning member is rotatably connected to the rotating head such that the first positioning member may remain stationary while the rotating head is rotating.

14. An apparatus for forming a reducer/expander duct member comprising:
a housing having a first position and a second position;
wherein the first position comprises an insertion channel for a first cylindrical work piece, a positioning member for a frustoconical work piece, and a means for coupling the cylindrical work piece to the frustoconical work piece;
wherein the second position comprises a second insertion channel for a second cylindrical work piece, a second positioning member for the frustoconical work piece, and a means for coupling the second cylindrical work piece to the frustoconical work piece.

15. The apparatus of claim 14, wherein the first positioning member is at least partially formed as a conical section.

16. The apparatus of claim 14, wherein the second positioning member is at least partially formed having a conical aperture.

17. The apparatus of claim 1 further comprising a part ejection system associated with the first workstation.

18. A method for forming a reducer/expander duct member for use in an air handling system comprising the steps of:
providing an apparatus having a first work station and a second work station;
inserting a first cylindrical work piece into an insertion channel of the first work station;
positioning a frustoconical work piece on a positioning member of the first work station,
coupling the first cylindrical work piece to the frustoconical work piece utilizing a die and coupling wheel associated with the first work station;
inserting a second cylindrical work piece into an insertion channel of the second work station;
positioning the frustoconical work piece on a positioning member of the second work station; and
coupling the second cylindrical work piece to the frustoconical work piece utilizing a die and coupling wheel associated with the second work station.
